(19) United States
(12) Patent Application Publication
(10) Pub. No.: US 2019/0310512 A1
(43) Pub. Date: Oct. 10, 2019

(54) LIQUID CRYSTAL DISPLAY DEVICE

(71) Applicant: SHARP KABUSHIKI KAISHA, Sakai City (JP)

(72) Inventors: KAZUNARI TANAKA, Sakai City (JP); RYUJI MATSUMOTO, Sakai City (JP); KAZUYA NAKAJIMA, Sakai City (JP)

(21) Appl. No.: 16/368,546

(22) Filed: Mar. 28, 2019

(30) Foreign Application Priority Data
Apr. 9, 2018 (JP) 2018-074845

(51) Int. Cl. G02F 1/1335; G02F 1/1333; G02F 1/1343

(52) U.S. Cl. CPC G02F 1/133528; G02F 2201/121; G02F 1/1343; G02F 1/133345

(57) ABSTRACT

The present invention provides a liquid crystal display device capable of suppressing light leakage and saving at least one polarizing plate. The liquid crystal display device is provided with multiple display units arranged in a matrix and includes, in the following order, a first insulating substrate, a planar common electrode having polarization superimposed with all of the display units and a boundary region between the display units adjacent to each other, a liquid crystal layer, a second insulating substrate, and a planar polarizing layer having polarization superimposed with all of the display units and the boundary region.

### CROSS-REFERENCE TO RELATED APPLICATIONS

The present application claims priority under 35 U.S.C. § 119 to Japanese Patent Application No. 2018-074845 filed on Apr. 9, 2018, the contents of which are incorporated herein by reference in their entirety.

### BACKGROUND OF THE INVENTION

### Field of the Invention

The present invention relates to liquid crystal display devices. The present invention particularly relates to a liquid crystal display device including a common electrode.

### Description of Related Art

Liquid crystal display devices utilize a liquid crystal composition for display. A typical display process includes applying voltage to a liquid crystal composition enclosed between a pair of substrates, changing the alignment state of liquid crystal molecules in the liquid crystal composition in response to the applied voltage, and thereby controlling the amount of light transmitted. Such liquid crystal display devices, having advantages of a thin profile, light weight, and low power consumption, are used in various fields.

As a technique for liquid crystal display devices, for example, JP 2008-3606 A discloses a liquid crystal display device including a first substrate, a second substrate, and a liquid crystal layer. The first substrate and the second substrate include on the back side surface thereof first and second alignment layers, respectively, each having properties of both an electrode and a polarizer. JP 2009-230130 A discloses a liquid crystal display device employing a transparent thin film electrode that polarizes light passing through the thin film electrode as at least one of electrodes for applying voltage to liquid crystals. JP 2009-31464 A discloses a liquid crystal display device that includes a first substrate and a second substrate facing to each other via a liquid crystal layer. The first substrate includes pixel electrodes and a common electrode. A conductive layer is disposed on the second substrate on the side remote from the liquid crystal layer. The conductive layer is a polarizing layer that has a transmission axis along which light polarized by the liquid crystal layer is selectively transmitted.

### BRIEF SUMMARY OF THE INVENTION

In a liquid crystal display device including a first substrate, a second substrate, and a liquid crystal layer held between the first substrate and the second substrate, typically, a polarizing plate is provided on each of the first substrate and the second substrate on the side remote from the liquid crystal layer. In such a liquid crystal display device, the amount of light transmitted can be controlled by a combination of the movement of liquid crystal molecules in the liquid crystal layer and the polarizing directions of the two polarizing plates.

Production of a liquid crystal display device typically requires steps regarding a polarizing plate, such as bonding a polarizing plate (polarizing film) to each of a first substrate and a second substrate and adjusting the bonding state of the polarizing plate. These steps increase the number of steps to possibly deteriorate the production performance. Additionally, material costs may increase if the polarizing plate is expensive or needs to have a size corresponding to the size of the liquid crystal display device. Liquid crystal display devices including polarizing plate(s) thus have been required to suppress the increase in production costs and the deterioration in productivity.

JP 2009-230130 A discloses, in Example 2, a TN mode liquid crystal display element including a transparent thin film electrode having polarization, in which a polarizing film is disposed on a substrate including the transparent thin film electrode on the side remote from a liquid crystal layer. Production of the liquid crystal display element disclosed in JP 2009-230130 A thus requires step(s) regarding the polarizing film, such as a step of bonding the polarizing film.

JP 2009-31464 A discloses a liquid crystal display device including an antistatic conductive layer on a second substrate on the side remote from a liquid crystal layer, in which the conductive layer is a polarizing layer. As an example of the polarizing layer, a conductive polarizing plate is proposed. Production of the liquid crystal display device disclosed in JP 2009-31464 A thus requires step(s) regarding the polarizing plate.

FIG. 5 is a schematic cross-sectional view of a liquid crystal display device of Comparative Embodiment 1. JP 2008-3606 A discloses a twisted nematic (TN) mode liquid crystal display device in which transparent electrodes having polarization are used for pixel electrodes and a common electrode. Examples of such a liquid crystal display device include a liquid crystal display device of Comparative Embodiment 1 as shown in FIG. 5. A liquid crystal display device 1R of Comparative Embodiment 1 includes a first insulating substrate 10R, a common electrode having polarization 20R, a first alignment film 51R, a liquid crystal layer 60R, a second alignment film 52R, pixel electrodes having polarization 41R, and a second insulating substrate 70R in the stated order from the viewing surface side. In Comparative Embodiment 1, a stack including the first insulating substrate 10R and the common electrode 20R is also referred to as a first substrate, and a stack including the second insulating substrate 70R and the pixel electrodes 41R is also referred to as a second substrate.

The liquid crystal display device 1R of Comparative Embodiment 1 includes no polarizing plate because the pixel electrodes 41R and the common electrode 20R, facing each other via the liquid crystal layer 60R, are both transparent electrodes having polarization. The present inventors studied such a liquid crystal display device 1R of Comparative Embodiment 1. The pixel electrodes 41R of the liquid crystal display device 1R of Comparative Embodiment 1 in adjacent pixels are separated by gaps. The gap has no polarization to possibly cause light leakage. A black matrix disposed between adjacent pixels is designed to suppress the light leakage. Unfortunately, the first substrate and the second substrate are often slightly shifted from each other because of local shift during fitting of the substrates, for example. In such a case, the black matrix fails to sufficiently suppress the light leakage from the gaps between adjacent pixels. Some TN mode liquid crystal display devices 1R include pixel electrodes 41R provided with slits to control the inclination of liquid crystal molecules. The slits have no polarization to possibly cause light leakage.

The present inventors further studied a liquid crystal display device 1R of Comparative Embodiment 2, which is a fringe field switching (FFS) mode liquid crystal display device that includes pixel electrodes having polarization and a common electrode having polarization. FIG. 6 is a schematic cross-sectional view of a liquid crystal display device of Comparative Embodiment 2. FIG. 7 is a schematic plan view of the liquid crystal display device of Comparative Embodiment 2. The liquid crystal display device 1R of Comparative Embodiment 2 includes the first insulating substrate 10R, the common electrode having polarization 20R, an interlayer insulating film 30R, the pixel electrodes having polarization 41R, the first alignment film 51R, the liquid crystal layer 60R, the second alignment film 52R, the second insulating substrate 70R, and a transparent electrode layer 80R in the stated order from the back surface side.

The pixel electrodes having polarization 41R are disposed in respective regions each partitioned by two adjacent source lines 91R and two adjacent gate lines 92R. Each pixel electrode having polarization 41R is provided with slits 40SR. The transparent electrode layer 80R has conductivity and prevents the liquid crystal display device 1R from charging.

In a liquid crystal display device utilizing a transverse electric field, such as the liquid crystal display device 1R of Comparative Embodiment 2, pixel electrodes or a common electrode are/is provided with slits. When the pixel electrodes having polarization 41R and the common electrode having polarization 20R are employed in the liquid crystal display device 1R utilizing a transverse electric field, the slits 40SR in the pixel electrodes 41R have no polarization to possibly cause light leakage.

The present invention has been made under the current situation in the art and aims to provide a liquid crystal display device capable of suppressing light leakage and saving at least one polarizing plate.

The present inventors made various studies on liquid crystal display devices capable of suppressing light leakage and saving at least one polarizing plate to find the following. That is, giving polarization to a planar common electrode superimposed with all of the display units and a boundary region between the display units adjacent to each other enables the common electrode to be used as a polarizing plate in the display units and in the boundary region. This can suppress light leakage from the slit portions in the pixel electrodes and from the boundary region and eliminate the need for disposing a polarizing plate at least on the side of the substrate including the common electrode. Thus, they successfully found a measure to the above issue to arrive at the present invention.

In other words, an aspect of the present invention may be a liquid crystal display device provided with multiple display units arranged in a matrix, including, in the following order, a first insulating substrate, a planar common electrode having polarization and superimposed with all of the display units and a boundary region between the display units adjacent to each other, a liquid crystal layer, a second insulating substrate, and a planar polarizing layer having polarization and superimposed with all of the display units and the boundary region.

The first insulating substrate, the common electrode, the liquid crystal layer, the second insulating substrate, and the polarizing layer may be disposed in the stated order from a back surface side, the liquid crystal display device may further include an interlayer insulating film on a liquid crystal layer side of the common electrode, and pixel electrodes provided with a slit on a liquid crystal layer side of the interlayer insulating film, the polarizing layer may have conductivity, and no polarizing plate may be disposed on the first insulating substrate and the second insulating substrate on a side remote from the liquid crystal layer.

The first insulating substrate, the common electrode, the liquid crystal layer, the second insulating substrate, and the polarizing layer may be disposed in the stated order from a viewing surface side, the liquid crystal display device may further include pixel electrodes disposed on a liquid crystal layer side of the second insulating substrate, and a polarizing plate including at least the polarizing layer, and no polarizing plate may be disposed on the first insulating substrate on a side remote from the liquid crystal layer.

The present invention can provide a liquid crystal display device capable of suppressing light leakage and saving at least one polarizing plate.

### BRIEF DESCRIPTION OF THE DRAWINGS

FIG. 1 is a schematic plan view of an FFS mode liquid crystal display device of Embodiment 1.

FIG. 2 is a schematic cross-sectional view of the FFS mode liquid crystal display device of Embodiment 1.

FIG. 3 is a schematic plan view of a TN mode liquid crystal display device of Embodiment 2.

FIG. 4 is a schematic cross-sectional view of the TN mode liquid crystal display device of Embodiment 2.

FIG. 5 is a schematic cross-sectional view of a liquid crystal display device of Comparative Embodiment 1.

FIG. 6 is a schematic cross-sectional view of a liquid crystal display device of Comparative Embodiment 2.

FIG. 7 is a schematic plan view of the liquid crystal display device of Comparative Embodiment 2.

FIG. 8 is a schematic cross-sectional view of an FFS mode liquid crystal display device of Comparative Embodiment 3.

FIG. 9 is a schematic cross-sectional view of a TN mode liquid crystal display device of Comparative Embodiment 4.

### DETAILED DESCRIPTION OF THE INVENTION

Embodiments of the present invention are described below. The embodiments, however, are not intended to limit the scope of the present invention, and modifications can be appropriately made to the design within the scope of the present invention. In the following description, the same reference symbols are used throughout the drawings to refer to identical elements or elements having similar functions, and repetitive descriptions are omitted. Features described in the embodiments may appropriately be combined or modified within the spirit of the present invention.

### Embodiment 1

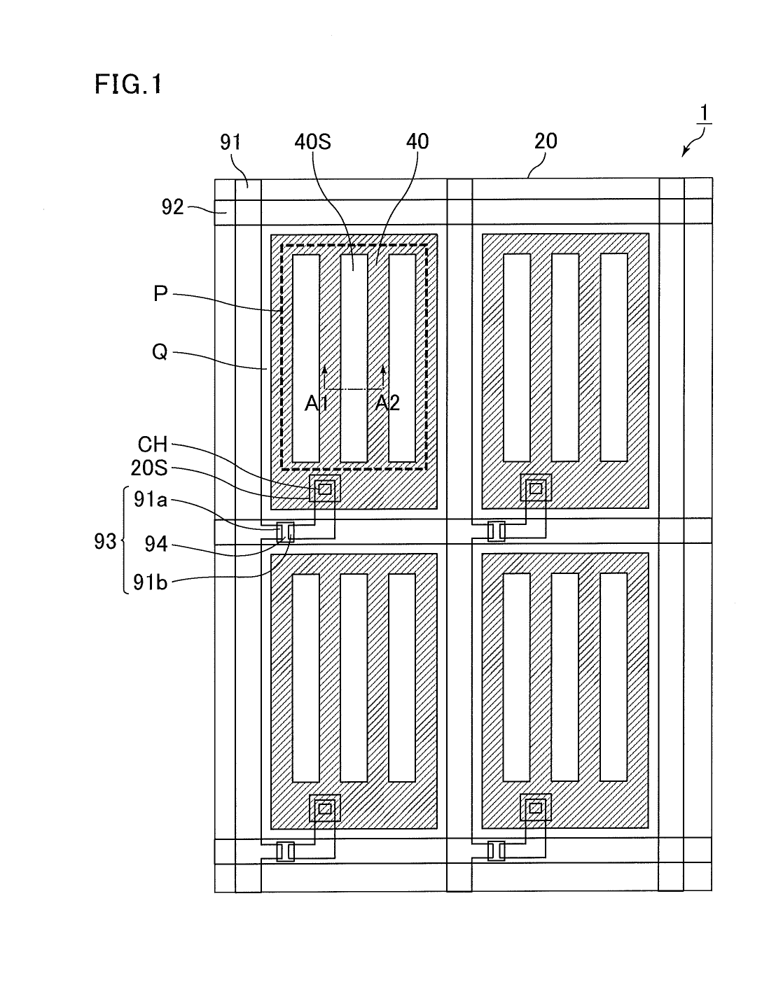

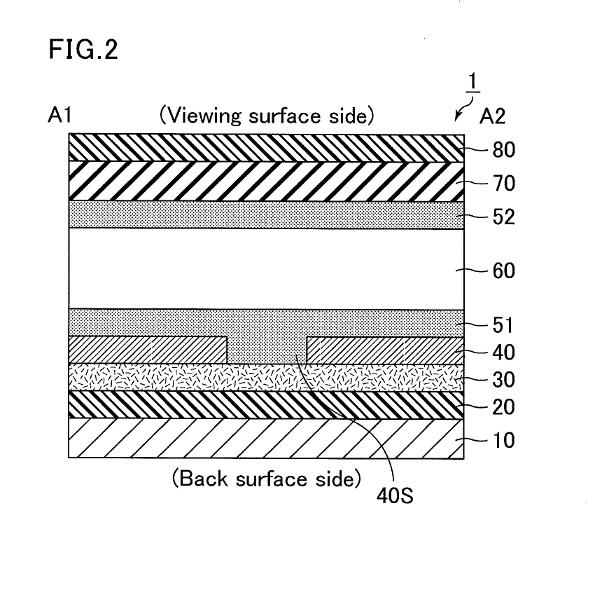

FIG. 1 is a schematic plan view of an FFS mode liquid crystal display device of Embodiment 1. FIG. 2 is a schematic cross-sectional view of the FFS mode liquid crystal display device of Embodiment 1. FIG. 2 is a schematic cross-sectional view taken along the line A1-A2 in FIG. 1. The present embodiment is described by exemplifying an FFS mode liquid crystal display device.

As shown in FIG. 1, a liquid crystal display device 1 of the present embodiment includes a display region provided with multiple display units P arranged in a matrix. As shown in FIG. 2, the liquid crystal display device 1 includes, in the following order, a first insulating substrate 10, a planar common electrode having polarization (counter electrode) 20 superimposed with all of the display units P and a boundary region Q between the display units P adjacent to each other, a liquid crystal layer 60, a second insulating substrate 70, and a planar polarizing layer having polarization 80 superimposed with all of the display units P and the boundary region Q. The common electrode 20, having polarization, thus can function as a polarizer, which eliminates the need for disposing a polarizing plate on the side of the substrate including the common electrode 20 in the liquid crystal display device 1. The “polarizer” as used herein means a product that converts natural light or polarized light into linearly polarized light. The display unit P is an aperture region and the boundary region Q is a light-blocking region.

In the liquid crystal display device 1R of Comparative Embodiment 2 including the pixel electrodes having polarization 41R, slit 40SR portions of the pixel electrodes 41R and the boundary region between the display units have no polarization to possibly cause light leakage. In contrast, in the present embodiment, the planar common electrode 20 having polarization and superimposed with all of the display units P and the boundary region Q can polarize light in the boundary region Q as well as in the display units P, which can suppress light leakage from the regions having no polarization. The present embodiment is described in detail below.

As shown in FIG. 2, the liquid crystal display device 1 of the present embodiment includes the first insulating substrate 10, the planar common electrode having polarization 20, an interlayer insulating film 30, the pixel electrodes 40, a first alignment film 51, the liquid crystal layer 60, a second alignment film 52, the second insulating substrate 70, and the conductive polarizing layer 80 in the stated order from the back surface side. A stack including the first insulating substrate 10, the planar common electrode having polarization 20, the interlayer insulating film 30, and the pixel electrodes 40 is also referred to as a thin film transistor (TFT) substrate.

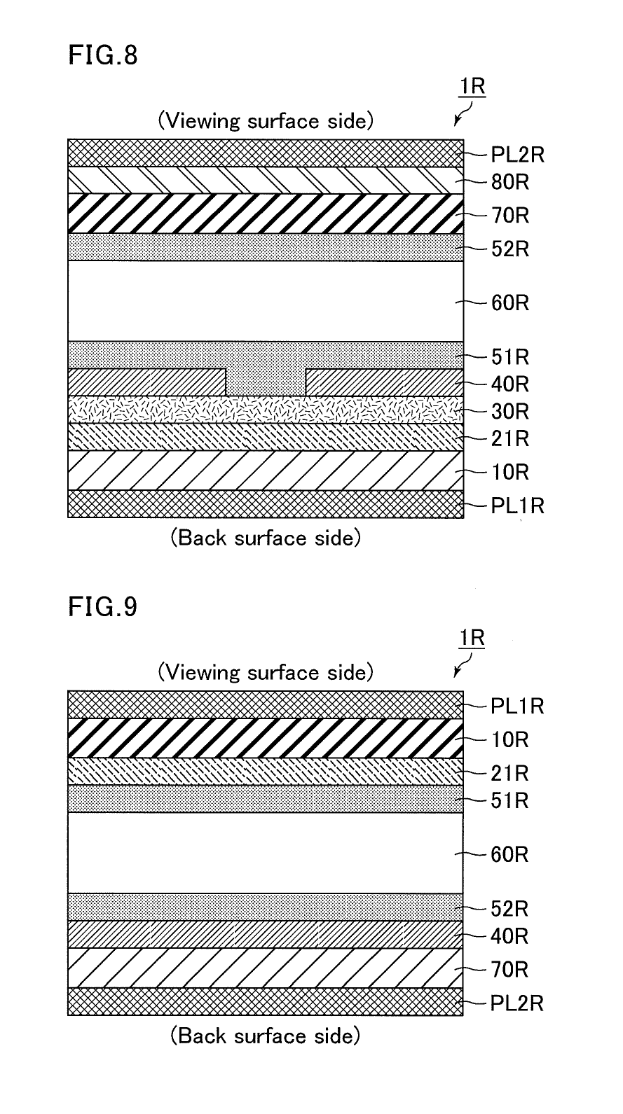

Here, a conventional FFS mode liquid crystal display device is described. FIG. 8 is a schematic cross-sectional view of an FFS mode liquid crystal display device of Comparative Embodiment 3. As shown in FIG. 8, a liquid crystal display device 1R of Comparative Embodiment 3, which is an example of a conventional FFS mode liquid crystal display device, includes a first polarizing plate PL1R, the first insulating substrate 10R, a common electrode 21R, the interlayer insulating film 30R, pixel electrodes 40R, the first alignment film 51R, the liquid crystal layer 60R, the second alignment film 52R, the second insulating substrate 70R, the transparent electrode layer 80R, and a second polarizing plate PL2R in the stated order from the back surface side.

A comparison between the structure of the liquid crystal display device 1 of the present embodiment and the structure of the liquid crystal display device 1R of Comparative Embodiment 3 shows that, in Comparative Embodiment 3, the first and second polarizing plates PL1R and PL2R are disposed on the first and second insulating substrates 10R and 70R, respectively, on the side remote from the liquid crystal layer 60R while such polarizing plates are not disposed in the present embodiment.

In the liquid crystal display device 1R of Comparative Embodiment 3, the first polarizing plate PL1R and the common electrode 21R are disposed in different layers. In the present embodiment, the planar common electrode having polarization 20 functions as both a common electrode and a polarizer, which eliminates the need for disposing a first polarizing plate on the TFT substrate side. In the liquid crystal display device 1R of Comparative Embodiment 3, the transparent electrode layer 80R functioning as an antistatic layer and the second polarizing plate PL2R are disposed in different layers. In the present embodiment, the conductive polarizing layer 80 functions as both an antistatic layer and a polarizer, which eliminates the need for disposing a second polarizing plate on the CF substrate side. The FFS mode liquid crystal display device 1 of the present embodiment thus includes a smaller number of members than the conventional FFS mode liquid crystal display device 1R of Comparative Embodiment 3.

Accordingly, a liquid crystal display device 1 of the present embodiment which requires no polarizing plate on the first insulating substrate 10 side can be achieved by forming a transparent polarizing thin film electrode in a step of forming a common electrode (transparent thin film electrode), which is an essential step in production of a liquid crystal display device. Similarly, a liquid crystal display device 1 of the present embodiment which requires no polarizing plate on the second insulating substrate 70 side can be achieved by forming a transparent conductive polarizing film in a step of forming a transparent conductive film such as an indium tin oxide (ITO) film on the viewing surface side of the second insulating substrate 70 in production of a liquid crystal display device. As described, in the present embodiment where a conductive material having polarization is employed to eliminate a conventional polarizing plate, the material costs and expenses for the polarizing plate can be reduced. Furthermore, the present embodiment can eliminate a step of bonding a polarizing plate and a step of adjusting the bonding state of the polarizing plate, which can reduce the number of the steps and improve the production performance.

As shown in FIG. 1, the first insulating substrate 10 in the liquid crystal display device 1 of the present embodiment includes source lines 91, gate lines 92 intersecting the source lines 91, and TFTs 93. A pixel electrode 40 provided with slits 40S is disposed in each region partitioned by two adjacent source lines 91 and two adjacent gate lines 92.

Each TFT 93 is connected to the corresponding source line 91 and the corresponding gate line 92 among multiple source lines 91 and multiple gate lines 92 and is a three-terminal switch including a thin film semiconductor 94, a source electrode 91a which is part of the corresponding source line 91, a gate electrode (not shown) which is part of the corresponding gate line 92, and a drain electrode 91b connected to the corresponding pixel electrode 40 among multiple pixel electrodes 40.

The pixel electrodes 40 are disposed in the respective display units P and are each connected to the corresponding source line 91 through the corresponding thin film semiconductor 94. Potential control by turning on or off of the gate line 92 allows supply of a source signal to the pixel electrode 40, whereby the pixel potential can be flexibly controlled. This enables generation of a fringe electric field between the pixel electrode 40 provided with the slits 40S and the planar common electrode 20 disposed in a layer under the pixel electrode 40 via the interlayer insulating film 30 to rotate liquid crystal molecules in the liquid crystal layer 60. In this manner, the amount of voltage applied between the pixel electrode 40 and the common electrode 20 is controlled to change the retardation of the liquid crystal layer 60, whereby transmitting/blocking of light is controlled.

The “display unit” as used herein means a region corresponding to one pixel electrode 40 and may be a unit called a “pixel” in the field of liquid crystal display devices. When one pixel is dividedly driven, the “display unit” may mean a unit referred to as a “subpixel” or “dot”.

The common electrode 20 is a planar electrode having polarization and superimposed with all of the display units P and the boundary region Q and thus may also be used as a polarizer. Here, in the liquid crystal display device of Comparative Embodiment 2 including the pixel electrodes having polarization 41R, the slit 40SR portions of the pixel electrodes 41R and the boundary region between the display units have no polarization to possibly cause light leakage. In contrast, in the present embodiment, the planar common electrode 20, having polarization and superimposed with all of the display units P and the boundary region Q, can polarize light in the boundary region Q as well as in the display units P, which can suppress light leakage from the regions having no polarization. As described, the common electrode 20 is disposed over the multiple display units P.

“Polarization” as used herein means a property that polarizes light. A member having polarization (the common electrode 20 and the polarizing layer 80, hereinafter also referred to as polarizing member(s)) has a polarization axis. The polarization degree of a polarizing member may be similar to that of a polarizing plate typically used in the field of liquid crystal display devices and may be 99.95% or higher, for example. The polarization degree may be determined by measuring the parallel transmittance (T_{P}) and the cross transmittance (T_{c}) of the polarizing member and substituting the values into the following formula. The parallel transmittance (T_{P}) is a transmittance of a parallelly stacked polarizer in which two identical polarizing members are superimposed with their absorption axes arranged parallel to each other. The cross transmittance (T_{c}) is a transmittance of a perpendicularly stacked polarizer in which two identical polarizing members are superimposed with their absorption axes arranged perpendicular to each other. The upper limit of the polarization degree of the polarizing member is not particularly limited and is 100% in theory, usually 99.999% or lower.

Polarization degree (%)={(T_{P-}T_{c})/(T_{P+}T_{c})}^{0.50}×100

The method for determining the polarization degree of the common electrode 20 and the polarizing layer 80 is more specifically described. First, two identical liquid crystal display devices 1 are prepared. A substrate including the target polarizing member (common electrode 20 or polarizing layer 80) is peeled from each liquid crystal display device 1. Each of the two peeled substrates is subjected to measurement of the parallel transmittance and the cross transmittance, and the polarization degree (hereinafter, also referred to as polarization degree before removing polarizing member) thereof is calculated. Then, the polarizing member is removed from each of the two peeled substrates by etching or the like. Each of the two substrates without the polarizing member is subjected to measurement of the parallel transmittance and the cross transmittance, and the polarization degree (hereinafter, also referred to as polarization degree after removing polarizing member) thereof is calculated. The polarization degree of each polarizing member can be determined by subtracting the polarization degree after removing polarizing member from the polarization degree before removing polarizing member. An alternative method is as follows. Two stacks are prepared each of which includes a glass substrate having a known polarization degree and a known transmittance and the target polarizing member. Each stack is subjected to measurement of the parallel transmittance and the cross transmittance, and the polarization degree thereof is calculated. The polarization degree of the polarizing member can be determined by removing (subtracting) the polarizing component (polarization degree) of the glass substrate. In the former measurement method, when the polarization degree after removing polarizing member is low enough to be ignored relative to the polarization degree before removing polarizing member, the polarization degree before removing polarizing member may be determined as the polarization degree of the polarizing member without subtracting the polarization degree after removing polarizing member from the polarization degree before removing polarizing member. In the latter measurement method, when the polarization degree of the glass substrate is low enough to be ignored relative to the polarization degree of the stack, the polarization degree of the stack may be determined as the polarization degree of the polarizing member without subtracting the polarization degree of the glass substrate from the polarization degree of the stack.

“Planar” as used herein means solid and involves a substantially planar state, more specifically a state partly including aperture(s). In the present embodiment, the planar common electrode having polarization 20 is superimposed with all of the display units P, and the pixel electrodes 40 each provided with the slits 40S are disposed above the planar common electrode having polarization 20. This structure enables the display units P as a whole to provide liquid crystal display using polarized light and can prevent light leakage due to unpolarized light in each display unit P. The positions of the common electrode 20 and the pixel electrodes 40 in the present embodiment may be switched. That is, an FFS mode liquid crystal display device can be provided by disposing a planar pixel electrode for each display unit and a common electrode having polarization provided with slits above the pixel electrodes. Unfortunately, when the common electrode having polarization is provided with slits, the slit portions have no polarization to possibly cause light leakage. Such light leakage can be suppressed by disposing the planar common electrode having polarization 20 superimposed with all of the display units P, as in the present embodiment. The planar common electrode having polarization 20 is disposed also in the boundary region Q between the display units P adjacent to each other. Thereby, in the boundary region Q, even if polarized light having passed through the common electrode 20 further passes through the second insulating substrate 70, the planar polarizing layer having polarization 80 superimposed with the boundary region Q can effectively block the polarized light. Thus, light leakage from the boundary region Q can also be suppressed. In the liquid crystal display device 1, a contact hole CH for connecting each pixel electrode 40 to the corresponding drain electrode 91b is formed at least in the interlayer insulating film 30. The common electrode 20 is thus disposed in the entire display region excepting apertures 20S that are superimposed with the respective contact holes CH. The contact holes CH and the apertures 20S are provided in the boundary region Q (light-blocking region) where the later-describing black matrix is disposed. The black matrix is designed to suppress light leakage from the apertures 20S formed in the common electrode 20. However, when two substrates are shifted from each other during fitting, for example, light leakage may occur from the apertures 20S. In the liquid crystal display device 1R of Comparative Embodiment 1, when two substrates are shifted from each other during fitting, light leakage occurs from a boundary between pixels. This light leakage may occur whenever the substrates are shifted upward, downward, leftward, or rightward. Meanwhile, in the present embodiment, light leakage from the apertures 20S does not occur when the substrates are shifted in the direction the black matrix covers the apertures 20S, for example. Even if light leakage occurs, the region is smaller than in. Comparative Embodiment 1. Accordingly, the structure in which no common electrode having polarization 20 is disposed in a region superimposed with the apertures 20S does not cause a serious problem.

The common electrode 20 has conductivity. The common electrode 20 has a resistivity of preferably 7.0×10⁻⁴ Ω/cm or lower, more preferably 3.0×10⁻⁴ Ω/cm or lower. The resistivity can be measured with a typical resistivity measurement device, such as a stylus surface profile measurement system NSPR-2400 available from ULVAC. The resistivity measurement using this device can be performed by four-probe measurement in which four probes are made directly in contact with the film surface. The lower limit of the resistivity of the common electrode 20 is not particularly limited and is usually 1.0×10⁻⁴ Ω/cm or higher, preferably 1.5×10⁻⁴ Ω/cm or higher.

The common electrode 20 can be formed from a conductive material that gives polarization. Specific examples thereof include a conductive polymer, a carbon nanotube, and a metal thin wire.

The conductive polymer is a polymer having conductivity and examples thereof include polythiophenes, polyacetylenes, polyanilines, polypyrroles, and derivatives of these. The common electrode 20 can be formed from a conductive polymer by a typical method for forming a polymer thin film. Specific examples of the method include coating, printing, transferring, and vapor deposition. Polarization can be given by a dynamic method such as rubbing, a method including applying a composition containing a conductive polymer, generating an electric field or a magnetic field, and thereby aligning molecules of the conductive polymer, or a method including performing alignment treatment to a substrate surface to which a composition containing a conductive polymer is applied and using the alignment property of the surface, for example.

The carbon nanotube may be a conventionally known product. Particularly preferred is one that has a high ratio of metal components that have a high electrical conductivity. The carbon nanotube is preferred to have a small amount of impurities, a small number of defects, and a high purity. The common electrode 20 can be formed from a carbon nanotube by a thin film forming method such as the chemical vapor deposition (CVD) method, the arc method, or the laser ablation method. Polarization can be given by a dynamic method such as rubbing, a method including applying a composition containing a carbon nanotube, generating an electric field or a magnetic field, and thereby aligning molecules of the carbon nanotube, or a method including performing alignment treatment to a substrate surface to which a composition containing a carbon nanotube is applied and using the alignment property of the surface, for example.

The metal thin wire may be formed from any metal that is processable into a thin wire and examples of the metal include aluminum, gold, silver, and chromium. The common electrode 20 can be formed from a metal thin wire by a method including making the metal adhere to a substrate and obtaining a thin wire pattern by electron-beam lithography or interference exposure, for example.

The polarizing layer 80 is a planar polarizing layer having polarization and superimposed with all of the display units P and the boundary region Q and thus can be used as a polarizer. The polarizing layer 80 has conductivity and thus can also be used as an antistatic layer. As described, the conductive polarizing layer 80 can function as a polarizer as well as an antistatic layer, which eliminates the need for disposing a polarizing plate on the second insulating substrate 70 side in the liquid crystal display device 1. The planar polarizing layer having polarization 80, being superimposed with the display units P and the boundary region Q, can polarize light in the boundary region Q as well as in the display units P to suppress light leakage from regions having no polarization.

The FFS mode liquid crystal display device 1 of the present embodiment includes the planar common electrode having polarization 20 disposed on the first insulating substrate 10 side and superimposed with all of the display units P and the boundary region Q, and the planar conductive polarizing layer 80 disposed on the second insulating substrate 70 side and superimposed with all of the display units P and the boundary region Q, with the liquid crystal layer 60 in between. In other words, the FFS mode liquid crystal display device 1 can include a planar layer having polarization and superimposed with all of the display units P and the boundary region Q on each of the first insulating substrate 10 side and the second insulating substrate 70 side with the liquid crystal layer 60 in between. This structure suppresses light leakage and eliminates the need for disposing a polarizing plate on each of the first insulating substrate 10 side and the second insulating substrate 20 side. In the present embodiment, the common electrode 20 and the polarizing layer 80 are disposed with their polarization axes arranged perpendicular to each other.

The polarizing layer 80 is disposed over the multiple display units P, i.e., disposed in the entire display region.

The polarization degree of the polarizing layer 80 may be similar to that of a polarizing plate typically used in the field of liquid crystal display devices and may be 99.95% or higher, for example.

The resistivity of the polarizing layer 80 is preferably 7.0×10⁻⁴ Ω/cm or lower, more preferably 3.0×10⁻⁴ Ω/cm or lower. The lower limit of the resistivity of the polarizing layer 80 is not particularly limited and is usually 1.0×10⁻⁴ Ω/cm or higher, preferably 1.5×10⁻⁴ Ω/cm or higher.

The polarizing layer 80 can be formed from a conductive material that can give polarization. Specific examples thereof include a conductive polymer, a carbon nanotube, and a metal thin wire. Preferred aspects of these materials and the method for forming the polarizing layer 80 from any of these materials are the same as those for the common electrode 20.

On the viewing surface side of the second insulating substrate 70 is disposed the conductive polarizing layer 80. The polarizing layer 80 is grounded with any conductive member. More specifically, for example, the polarizing layer 80 is electrically connected to a neutralized terminal portion (not shown) provided on the first insulating substrate 10 with a conductive paste (not shown). The neutralized terminal portion is electrically connected to a reference potential point through a ground line (not shown) disposed on a flexible substrate (not shown) included in the liquid crystal display device 1. The conductive polarizing layer 80 grounded in this manner enables static elimination on the second insulating substrate 70 side. In other words, the polarizing layer 80 can also be used as an antistatic layer. The neutralized terminal portion can be provided at any site as long as it can eliminate static electricity when grounded, and can be provided on the viewing surface side of the first insulating substrate 10 or on the back surface side of the first insulating substrate 10.

The first insulating substrate 10 and the second insulating substrate 70 may each be a transparent insulating substrate such as a glass substrate or a plastic substrate.

The interlayer insulating film 30 insulates the common electrode 20 and the pixel electrodes 40. The interlayer insulating film 30 may be an inorganic insulating film, an organic insulating film, or a stack of an organic insulating film and an inorganic insulating film. Example of the inorganic insulating film include an inorganic film of a substance such as silicon nitride (SiNx) or silicon oxide (SiO2) (relative dielectric constant ε=5 to 7) and a multilayer film of these. Examples of the organic insulating film include an organic film having a small relative dielectric constant (relative dielectric constant ε=3 to 4), such as a photosensitive acrylic resin.

The pixel electrodes 40 can be formed from, for example, a transparent conductive material such as indium tin oxide (ITO), indium zinc oxide (IZO), zinc oxide (ZnO), tin oxide (SnO), or an alloy of these.

The liquid crystal layer 60 contains a liquid crystal material and controls the amount of light transmitted by applying voltage to the liquid crystal layer 60 and thereby changing the alignment state of liquid crystal molecules in the liquid crystal material in response to the applied voltage.

The liquid crystal material used in the present embodiment may have positive or negative anisotropy of dielectric constant (Δε) defined by the below formula. A liquid crystal material having positive anisotropy of dielectric constant is also referred to as a positive liquid crystal material. A liquid crystal material having negative anisotropy of dielectric constant is also referred to as negative liquid crystal material. The direction of the major axes of the liquid crystal molecules corresponds to the direction of the slow axis. Liquid crystal molecules are homogeneously aligned with no voltage applied (in a no-voltage applied state). The direction of the major axes of the liquid crystal molecules in the no-voltage applied state is also referred to as the direction of initial alignment of the liquid crystal molecules.

Δε=(dielectric constant in major axis direction)−(dielectric constant in minor axis direction)

The anisotropy of dielectric constant (Δε) of a liquid crystal material can be determined by producing a horizontally aligned liquid crystal cell and calculating the dielectric constant in the major axis direction and the dielectric constant in the minor axis direction using the capacitance values before and after high voltage application.

The first and second alignment films 51 and 52 control the alignment of liquid crystal molecules in the liquid crystal layer 60. When the voltage applied to the liquid crystal layer 60 is less than the threshold voltage (including no-voltage application), the alignment of liquid crystal molecules in the liquid crystal layer 60 is mainly controlled by the function of the first alignment film 51 and the second alignment film 52. In this state (hereinafter, also referred to as initial alignment state), an angle formed by the major axis of each liquid crystal molecule with respect to the surface of the first insulating substrate 10 and the second insulating substrate 70 is called a “pre-tilt angle”. The “pre-tilt angle” as used herein means an angle of inclination of a liquid crystal molecule from the direction parallel to a substrate surface. Specifically, an angle parallel to the substrate surface is 0° and an angle of a normal line of the substrate surface is 90°. The first alignment film 51 and the second alignment film 52 (horizontal alignment films) substantially horizontally align the liquid crystal molecules in the liquid crystal layer 60. The pre-tilt angle of the liquid crystal molecules is preferably 0° or greater and 5° or smaller.

On the second insulating substrate 70 is disposed a black matrix (not shown) formed in a grid pattern. The black matrix defines the boundary region Q (light-blocking region). When one pixel is dividedly driven, a color filter (CF) is disposed in each aperture portion (subpixel) of the grid-patterned black matrix. Each color filter is superimposed with the corresponding display unit P (aperture region). A stack including the second insulating substrate 70, the color filters, and the black matrix is also referred to as a CF substrate.

### Embodiment 2

In the present embodiment, features unique to the present embodiment are mainly explained and description of the same points as in the above embodiment is omitted. Embodiment 1 was described by exemplifying an FFS mode liquid crystal display device while the present embodiment is described by exemplifying a TN mode liquid crystal display device.

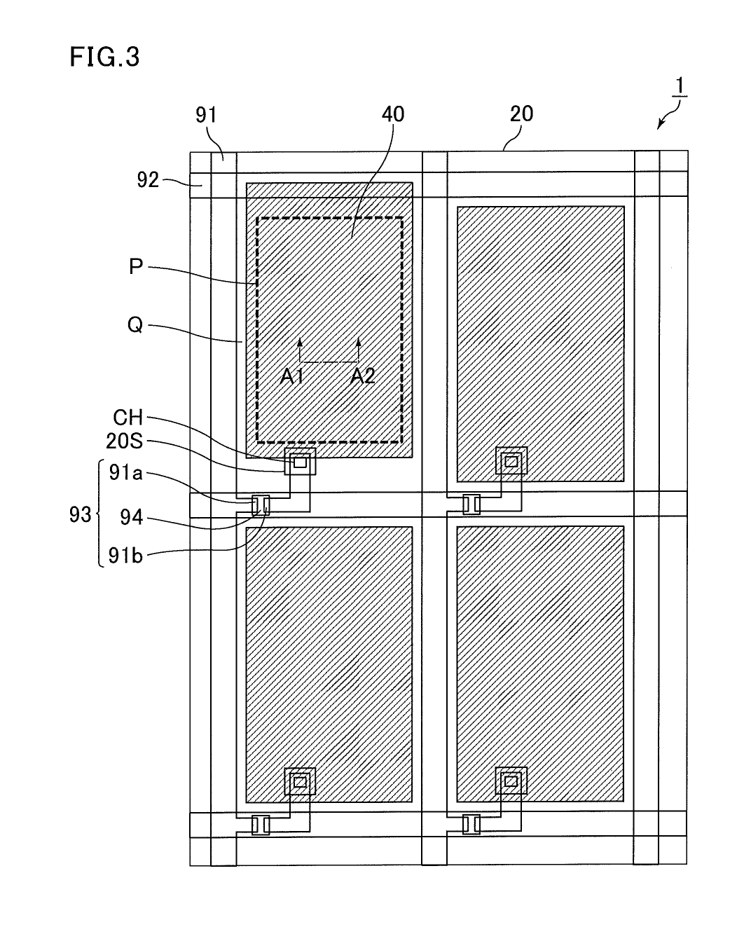

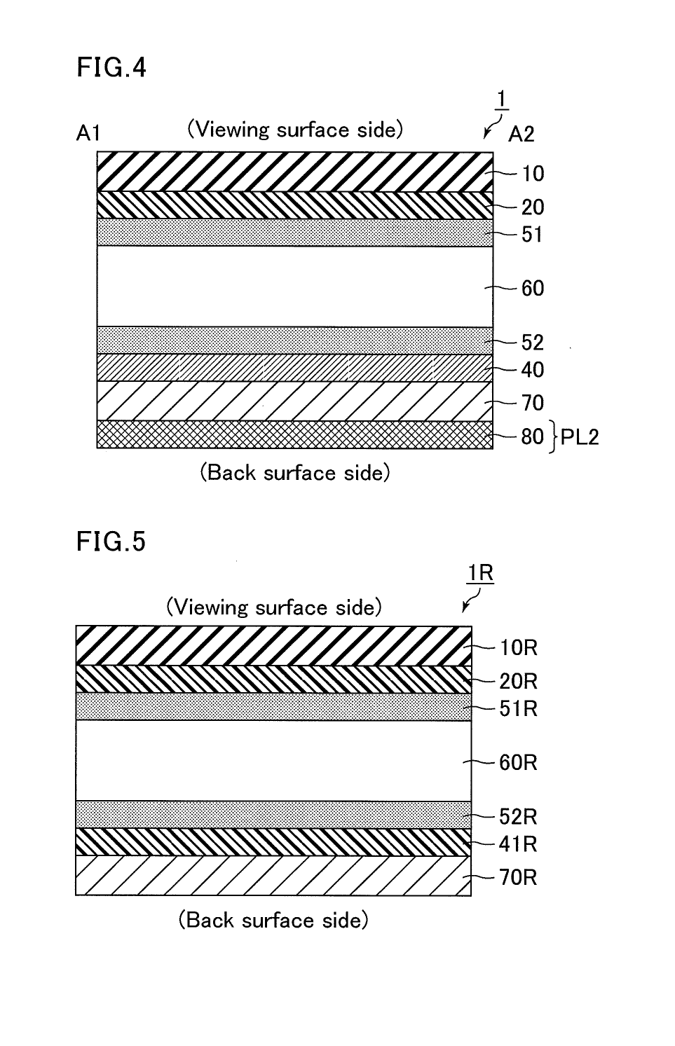

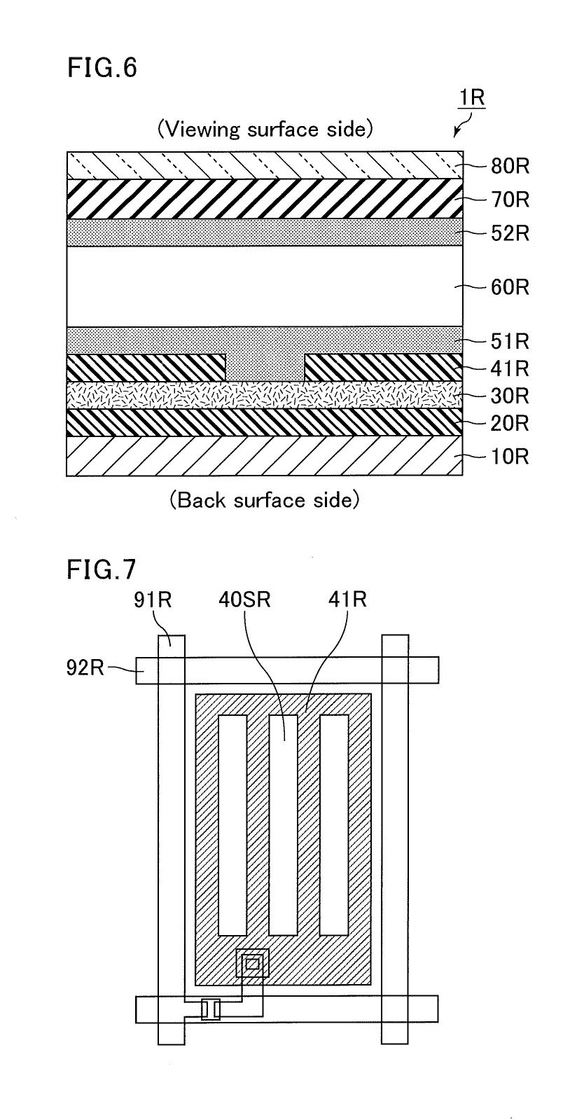

FIG. 3 is a schematic plan view of a TN mode liquid crystal display device of Embodiment 2. FIG. 4 is a schematic cross-sectional view of the TN mode liquid crystal display device of Embodiment 2. FIG. 4 is a schematic cross-sectional view taken along the line A1-A2 in FIG. 3.

As shown in FIG. 4, a liquid crystal display device 1 of the present embodiment includes, in the following order, the first insulating substrate 10, the planar common electrode having polarization 20 superimposed with all of the display units P and the boundary region Q between the display units P adjacent to each other, the liquid crystal layer 60, the second insulating substrate 70, and the planar polarizing layer having polarization 80 superimposed with all of the display units P and the boundary region Q. The common electrode having polarization 20, which can also function as a polarizer, eliminates the need for disposing a polarizing plate on the side of the substrate including the common electrode 20 in the liquid crystal display device 1.

In the liquid crystal display device 1R of Comparative Embodiment 1 including the pixel electrodes having polarization 41R, the slit 40SR portions of the pixel electrodes 41R and the boundary region between the display units have no polarization to possibly cause light leakage. In contrast, in the present embodiment, the planar common electrode 20, having polarization and superimposed with all of the display units P and the boundary region Q, can polarize light in the boundary region Q as well as in the display units P, which suppresses light leakage from the regions having no polarization. The present embodiment is described in detail below.

As shown in FIG. 3 and FIG. 4, the liquid crystal display device 1 of the present embodiment includes the first insulating substrate 10, the planar common electrode having polarization 20, the first alignment film 51, the liquid crystal layer 60, the second alignment film 52, the pixel electrodes 40, the second insulating substrate 70, and a polarizing plate PL2 including the polarizing layer 80, in the stated order from the viewing surface side.

Here, a conventional TN mode liquid crystal display device is described. FIG. 9 is a schematic cross-sectional view of a TN mode liquid crystal display device of Comparative Embodiment 4. As shown in FIG. 9, a liquid crystal display device 1R of Comparative Embodiment 4, which is an example of a conventional TN mode liquid crystal display device, includes the first polarizing plate PL1R, the first insulating substrate 10R, the common electrode 21R, the first alignment film 51R, the liquid crystal layer 60R, the second alignment film 52R, the pixel electrodes 40R, the second insulating substrate 70R, and the second polarizing plate PL2R in the stated order from the viewing surface side.

A comparison between the structure of the liquid crystal display device 1 of the present embodiment and the structure of the liquid crystal display device 1R of Comparative Embodiment 4 shows that, in Comparative Embodiment 4, the first polarizing plate PL1R is disposed on the first insulating substrate 1OR on the side remote from the liquid crystal layer 60R while no such polarizing plate is disposed in the present embodiment.

In the liquid crystal display device 1R of Comparative Embodiment 4, the first polarizing plate PL1R and the common electrode 21R are disposed in different layers. In contrast, in the present embodiment, the planar common electrode having polarization 20 functions as a common electrode and a polarizer, which eliminates the need for disposing a first polarizing plate on the CF substrate side. The TN mode liquid crystal display device 1 of the present embodiment thus includes a smaller number of members than the conventional TN mode liquid crystal display device 1R of Comparative Embodiment 4.

Accordingly, the liquid crystal display device 1 of the present embodiment which requires no polarizing plate on the first insulating substrate 10 side can be achieved by forming a transparent polarizing thin film electrode (common electrode) in a step of forming the common electrode, which is an essential step for production of a liquid crystal display device.

As described in Comparative Embodiment 4, in a TN mode liquid crystal display device, the common electrode on the first insulating substrate side is the only layer employing a transparent electrode over the entire panel. If this liquid crystal display device employs a transparent polarizing electrode for each of the pixel electrodes and the common electrode as in Comparative Embodiment 2, light leakage may occur from gaps between the pixel electrodes and from the slit portions of the pixel electrodes. The present embodiment therefore employs a transparent polarizing electrode only for the common electrode 20 on the first insulating substrate 10 side, which achieves a liquid crystal display device that includes no polarizing plate on the first insulating substrate 10 side. Employing a transparent polarizing electrode for the transparent electrode portion on the first insulating substrate 10 side eliminates the need for disposing a polarizing plate on the CF substrate side in a conventional TN mode liquid crystal display device, which can reduce the material costs and expenses for the polarizing plate (to a half, for example). Moreover, a step of bonding the polarizing plate and a step of adjusting the bonding state of the polarizing plate can be eliminated, which reduces the production steps to improve the production performance.

With no voltage applied, liquid crystal molecules in the liquid crystal layer 60 are aligned parallel to the polarization axis of the common electrode 20 in the vicinity of the first alignment film 51 and are aligned parallel to the polarization axis of the polarizing layer 80 in the vicinity of the second alignment film 52. As described above, the polarization axis of the common electrode 20 and the polarization axis of the polarizing layer 80 are perpendicular to each other. Thus, in the liquid crystal layer 60, liquid crystal molecules are twisted by 90 degrees in one direction from the common electrode 20 side to the polarizing layer 80 side. The liquid crystal material used in the present embodiment is a positive liquid crystal material. With voltage applied to the liquid crystal layer 60, liquid crystal molecules are aligned perpendicular to the first insulating substrate 10 and the second insulating substrate 70. The amount of voltage applied between the pixel electrode 40 and the common electrode 20 is controlled to change the alignment of the liquid crystal molecules, whereby transmitting/blocking of light is controlled.

In the present embodiment, the planar common electrode having polarization 20 superimposed with all of the display units P and the pixel electrodes 40 disposed in the respective display units P are faced to each other via the liquid crystal layer 60. Thereby, even when slits are provided in the pixel electrodes 40 to control the inclination of liquid crystal molecules, the display units P as a whole can provide liquid crystal display using polarized light while light leakage due to unpolarized light can be suppressed in each display unit P. The planar common electrode 20 is disposed also in the boundary region Q between the display units P adjacent to each other, which can also suppress light leakage from the boundary region Q as in Embodiment 1.

The polarizing plate PL2 includes the polarizing layer 80 and two protective films holding the polarizing layer 80 in between. The polarizing plate PL2 is disposed over the multiple display units P, i.e., disposed in the entire display region. The polarizing layer 80 of Embodiment 1 has conductivity while the polarizing layer 80 of the present embodiment may or may not have conductivity. The surface resistivity of the polarizing layer 80 in the present embodiment is not particularly limited. The polarizing layer 80 of the present embodiment may be a conventionally known polarizer such as a polarizer produced by dispersing iodine and a dye in polyvinyl alcohol (PVA) and stretching the PVA.

As in Embodiment 1, the polarization degree of the polarizing layer 80 in the present embodiment may be similar to that of a polarizing plate typically used in the field of liquid crystal display devices and may be 99.95% or higher, for example. The upper limit of the polarization degree of the polarizing layer 80 is not particularly limited and is 100% in theory, usually 99.999% or lower.

The protective film is a film for protecting the polarizing layer 80 and is preferably a film having a low birefringence. The material for the protective film is preferably triacetyl cellulose (TAC), for example. Examples of a material having a law birefringence include cyclo olefin resins and fluorene resins. The protective film may be formed from glass.

What is claimed is:

1. A liquid crystal display device provided with multiple display units arranged in a matrix, comprising, in the following order:
a first insulating substrate;
a planar common electrode having polarization and superimposed with all of the display units and a boundary region between the display units adjacent to each other;
a liquid crystal layer;
a second insulating substrate; and
a planar polarizing layer having polarization and superimposed with all of the display units and the boundary region.

2. The liquid crystal display device according to claim 1,
wherein the first insulating substrate, the common electrode, the liquid crystal layer, the second insulating substrate, and the polarizing layer are disposed in the stated order from a back surface side,
the liquid crystal display device further comprises an interlayer insulating film on a liquid crystal layer side of the common electrode, and pixel electrodes provided with a slit on a liquid crystal layer side of the interlayer insulating film,
the polarizing layer has conductivity, and
no polarizing plate is disposed on the first insulating substrate and the second insulating substrate on a side remote from the liquid crystal layer.

3. The liquid crystal display device according to claim 1,
wherein the first insulating substrate, the common electrode, the liquid crystal layer, the second insulating substrate, and the polarizing layer are disposed in the stated order from a viewing surface side,
the liquid crystal display device further comprises pixel electrodes disposed on a liquid crystal layer side of the second insulating substrate, and a polarizing plate including at least the polarizing layer, and
no polarizing plate is disposed on the first insulating substrate on a side remote from the liquid crystal layer.
